(19) United States
(12) Patent Application Publication
(10) Pub. No.: US 2014/0056700 A1
(43) Pub. Date: Feb. 27, 2014

(54) COMPRESSOR INLET HOUSING AND METHOD OF MANUFACTURING

(71) Applicants: Caroline Rupp, Manchester, CT (US); Craig Matthew Beers, Wethersfield, CT (US); Lino Sebastiano Italia, Rocky Hill, CT (US)

(72) Inventors: Caroline Rupp, Manchester, CT (US); Craig Matthew Beers, Wethersfield, CT (US); Lino Sebastiano Italia, Rocky Hill, CT (US)

(73) Assignee: HAMILTON SUNDSTRAND CORPORATION, Windsor Locks, CT (US)

(21) Appl. No.: 13/595,503

(22) Filed: Aug. 27, 2012

(51) Int. Cl. F04D 29/40; B23P 13/00

(52) U.S. Cl. 415/182.1; 29/557

(57) ABSTRACT

A compressor inlet housing includes an aft region having a radially inner surface defining an inner diameter and a radially outer surface defining an outer diameter. Also included is an O-ring groove extending around at least a portion of the aft region within the radially outer surface, the O-ring groove including a groove width, a groove depth and a groove diameter. The O-ring groove also includes an axially forward face, an axially aft face and a circumferential face disposed radially outwardly from the radially inner surface. The compressor inlet housing further includes an O-ring seal simultaneously disposed in contact with the axially forward face, the axially aft face and the circumferential face.

### BACKGROUND OF THE INVENTION

The present invention relates to cooling systems, and more particularly to compressor inlet housings for such cooling systems, as well as a method of manufacturing a compressor inlet housing.

O-ring seal arrangements are employed in a wide variety of applications for sealing purposes. Typically, the O-ring seal is seated within an O-ring groove and compressed to cause a reactive force which seals a passage between two surfaces and regions. As pressure is applied to compress the seal, the seal often displaces against a wall of the O-ring groove, thereby distorting the seal further and providing an increased reactive force on the two surfaces to be sealed. Such an arrangement is suitable when high pressure is consistently applied on one side of the seal since the seal is moved against the same wall of the O-ring groove. However, some applications require high pressure conditions and vacuum operation proximate one side of the seal. Under vacuum operation, the seal moves to a distinct wall, thereby leaving a void proximate the other wall. During such a condition, dirt, contaminants, and foreign objects may fall into the void, which unfortunately cause damage to the seal when reenergized at high pressure. Such damage results in leakage of oil, refrigerant and air, among other undesirable effects.

### BRIEF DESCRIPTION OF THE INVENTION

According to one embodiment, a compressor inlet housing includes an aft region having a radially inner surface defining an inner diameter and a radially outer surface defining an outer diameter. Also included is an O-ring groove extending around at least a portion of the aft region within the radially outer surface, the O-ring groove including a groove width, a groove depth and a groove diameter. The O-ring groove also includes an axially forward face, an axially aft face and a circumferential face disposed radially outwardly from the radially inner surface. The compressor inlet housing further includes an O-ring seal simultaneously disposed in contact with the axially forward face, the axially aft face and the circumferential face

According to another embodiment, a method of manufacturing a compressor inlet housing includes machining an O-ring groove within a radially outer surface of an aft region of the compressor inlet housing. Also included is defining the O-ring groove with an axially forward face, an axially aft face and a circumferential face disposed radially outwardly from a radially inner surface of the aft region of the compressor inlet housing, wherein the axially forward face, the axially aft face and the circumferential face define a groove width, a groove depth and a groove diameter. Further included is dimensionally spacing the axially forward face, the axially aft face and the circumferential face to fittingly accommodate an O-ring seal simultaneously disposed in contact with the axially forward face, the axially aft face and the circumferential face.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective, cross-sectional view of a compressor inlet housing disposed adjacent to a compressor motor housing;

FIG. 2 is a side, elevational view of the compressor inlet housing;

FIG. 3 is a side, cross-sectional view of the compressor inlet housing;

FIG. 4 is an enlarged view of an O-ring groove disposed along an aft region of the compressor inlet housing according to section IV of FIG. 3;

FIG. 5 is a cross-sectional view of an O-ring seal disposed in the O-ring groove; and

FIG. 6 is a flow diagram illustrating a method of manufacturing the compressor inlet housing.

### DETAILED DESCRIPTION OF THE INVENTION

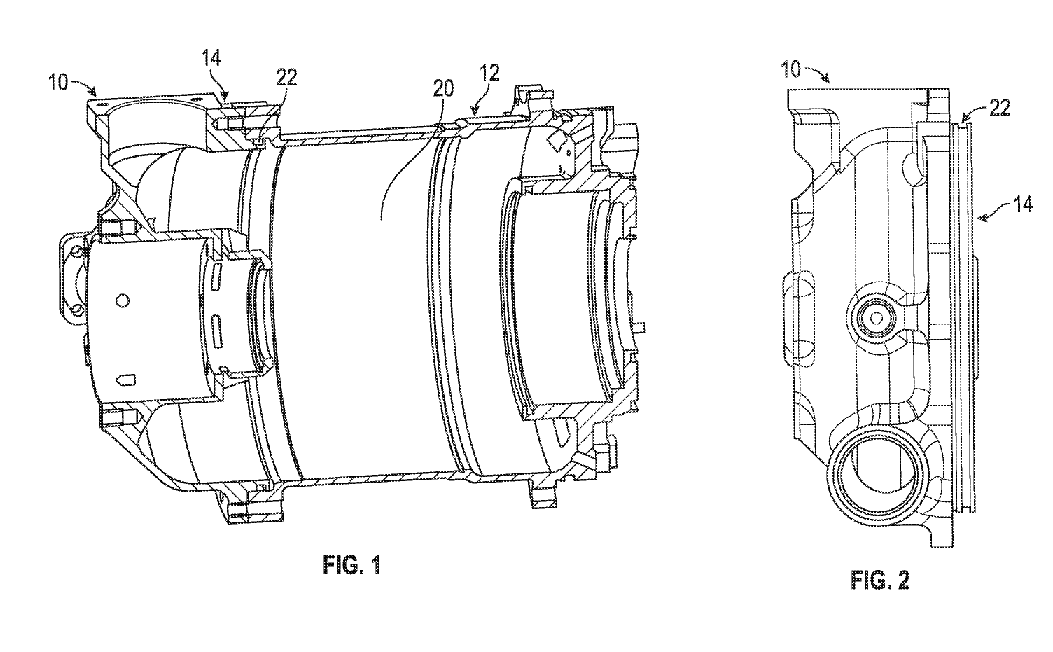

Referring to FIG. 1, a compressor inlet housing 10 and a compressor motor housing 12 are generally illustrated, both the compressor inlet housing 10 and the compressor motor housing 12 providing structural enclosures for a variety of components to be employed in conjunction with an application of use. The particular application may vary widely, with one exemplary embodiment related to a cooling system, such as a primary or supplemental cooling unit and/or cargo refrigeration unit disposed on an aircraft. As noted above, the compressor inlet housing 10 and the compressor motor housing 12 may be used in numerous applications and the embodiments listed above are merely illustrative and not limiting.

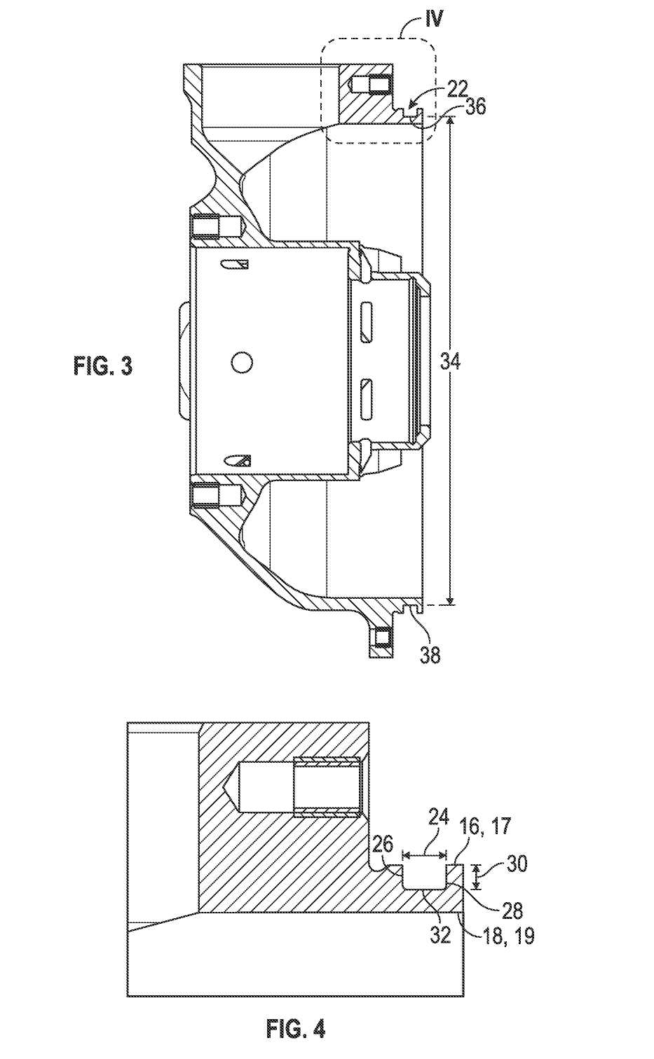

Referring now to FIGS. 2-4, in conjunction with FIG. 1, the compressor inlet housing 10 includes an aft region 14 that is fixable to the compressor motor housing 12. The aft region 14 includes a radially outer surface 16 defining an outer diameter 17 and a radially inner surface 18 defining an inner diameter 19 enclosing a portion of an inner chamber 20. The compressor inlet housing 10 and the compressor motor housing 12, when fixed to each other, define the inner chamber 20 that is operated at a relatively high pressure (i.e., above atmospheric pressure), however, the inner chamber 20 may be subjected to a relatively low pressure (i.e., below atmospheric pressure) during a vacuum operation of the inner chamber 20, which may occur for a variety of purposes, with one such purpose including purging of a refrigerant used in conjunction with the overall system.

In order to effectively control the desired pressurized environment within the inner chamber 20, an O-ring seal groove 22 extends around at least a portion of the aft region 14 within the radially outer surface 16. The O-ring groove 22 is configured to accommodate an O-ring seal (not shown) to provide a seal between the inner chamber 20 and an exterior region. The O-ring groove 22 includes a groove width 24 that is defined by an axially forward face 26 and an axially aft face 28. The O-ring groove 22 also includes a groove depth 30 that is defined by a circumferential face 32 that is disposed radially outwardly from the radially inner surface 18 and the radially outer surface 16 of the aft region 14. Another dimension defining the O-ring groove 22 is a groove diameter 34 that is measured from a first location 36 of the circumferential face 32 and a second, oppositely disposed location 38 (i.e., two distant points) of the circumferential face 32.

The dimensions described in detail above may vary depending on the application, however, in an exemplary embodiment the relationships between the dimensions achieve greater sealing, particularly when used with industry standardized O-ring seals. Specifically, the relationships include a width ratio and a depth ratio. The width ratio is defined by the groove width 24 divided by the groove diameter 34, while the depth ratio is defined by the groove depth 30 divided by the groove diameter 34. Therefore, the following equations define the width ratio and the depth ratio:

$$Width ratio = \frac{W}{G}$$

$$Depth ratio = \frac{D}{G}$$

, where W represents the groove width 24, G represents the groove diameter 34 and D represents the groove depth 30.

In one exemplary embodiment, the width ratio ranges from about 0.0267 to about 0.0283 and the depth ratio ranges from about 0.0156 to about 0.0161. The precise dimensions associated with the ratios described above will vary based on the particular application, however, in one embodiment the groove width 24 ranges from about 0.168 inches (about 4.267 mm) to about 0.178 inches (about 4.521 mm), the groove diameter 34 ranges from about 6.296 inches (about 159.9 mm) to about 6.300 inches (about 160.0 mm), and the groove depth 30 ranges from about 0.098 inches (about 2.489 mm) to about 0.101 inches (about 2.565 mm).

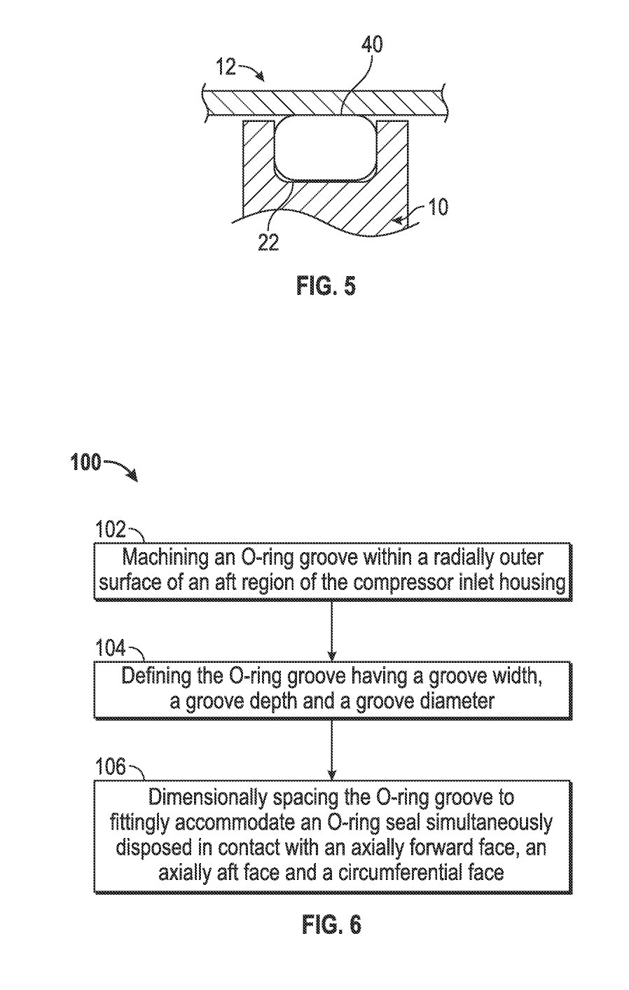

Referring now to FIG. 5, in operation, by employing the ratios described above, an O-ring seal 40 is disposed within the O-ring groove 22 in a compressed manner that does not permit displacement or shucking of the O-ring seal 40 back and forth between the axially forward face 26 and the axially aft face 28 during various operating conditions of the overall system. Specifically, the O-ring seal 40 is fixed in the same location during operation of the inner chamber 20 at relatively high pressure and relatively low pressure, based on the simultaneous contact of the O-ring seal 40 with the axially forward face 26, the axially aft face 28 and the circumferential face 32. Such an arrangement advantageously reduces the likelihood of foreign object damage of the O-ring seal 40.

A method of manufacturing a compressor inlet housing 100 is also provided as illustrated in FIG. 6 and with reference to FIGS. 1-5. The compressor inlet housing 10 and more specifically the O-ring groove 22 have been previously described and specific structural components need not be described in further detail. The method for manufacturing a compressor inlet housing 100 includes machining an O-ring groove 102 within a radially outer surface of an aft region of the compressor inlet housing. The O-ring groove is defined by an axially forward face, an axially aft face and a circumferential face that, in conjunction, define a groove width, a groove depth and a groove diameter 104. The axially forward face, the axially aft face and the circumferential face are dimensionally spaced 106 by the width ratio, as described above. The depth ratio also may be employed to dimensionally space the O-ring groove 22. The precise ratios and dimensions of the O-ring groove 22 are described in detail above and similar numerical ratios and dimensions are employed to carry out the method of manufacturing a compressor inlet housing 100.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A compressor inlet housing comprising:
an aft region having a radially inner surface defining an inner diameter and a radially outer surface defining an outer diameter;
an O-ring groove extending around at least a portion of the aft region within the radially outer surface, the O-ring groove comprising:
a groove width, a groove depth and a groove diameter; and
an axially forward face, an axially aft face and a circumferential face disposed radially outwardly from the radially inner surface; and
an O-ring seal simultaneously disposed in contact with the axially forward face, the axially aft face and the circumferential face.

2. The compressor inlet housing of claim 1, wherein a width ratio defined by the groove width in relation to the groove diameter ranges from about 0.0267 to about 0.0283.

3. The compressor inlet housing of claim 2, wherein the groove width ranges from about 0.168 inches (about 4.267 mm) to about 0.178 inches (about 4.521 mm) and the groove diameter ranges from about 6.296 inches (about 159.9 mm) to about 6.300 inches (about 160.0 mm).

4. The compressor inlet housing of claim 1, wherein a depth ratio defined by the groove depth in relation to the groove diameter ranges from about 0.0156 to about 0.0161.

5. The compressor inlet housing of claim 4, wherein the groove depth ranges from about 0.098 inches (about 2.489 mm) to about 0.101 inches (about 2.565 mm).

6. The compressor inlet housing of claim 1, wherein the groove diameter is defined by a first location of the circumferential face and a second, oppositely disposed location of the circumferential face.

7. The compressor inlet housing of claim 1, wherein the groove width is defined by a distance between the axially forward face and the axially aft face.

8. The compressor inlet housing of claim 1, wherein the groove depth is defined by a distance between extending from the radially outer surface of the aft region of the compressor inlet housing and the circumferential face of the O-ring groove.

9. The compressor inlet housing of claim 1, wherein the aft region is fixable to a compressor motor housing.

10. A method of manufacturing a compressor inlet housing comprising:
machining an O-ring groove within a radially outer surface of an aft region of the compressor inlet housing;
defining the O-ring groove with an axially forward face, an axially aft face and a circumferential face disposed radially outwardly from a radially inner surface of the aft region of the compressor inlet housing, wherein the axially forward face, the axially aft face and the circumferential face define a groove width, a groove depth and a groove diameter; and
dimensionally spacing the axially forward face, the axially aft face and the circumferential face to fittingly accommodate an O-ring seal simultaneously disposed in contact with the axially forward face, the axially aft face and the circumferential face.

11. The method of claim 10, further comprising dimensionally spacing the axially forward face, the axially aft face and the circumferential face with a width ratio defined by the groove width in relation to the groove diameter, the width ratio ranging from about 0.0267 to about 0.0283.

12. The method of claim 11, wherein the groove width ranges from about 0.168 inches (about 4.267 mm) to about 0.178 inches (about 4.521 mm) and the groove diameter ranges from about 6.296 inches (about 159.9 mm) to about 6.300 inches (about 160.0 mm).

13. The method of claim 10, further comprising dimensionally spacing the axially forward face, the axially aft face and the circumferential face with a depth ratio defined by the groove depth in relation to the groove diameter, the depth ratio ranging from about 0.0156 to about 0.0161.

14. The method of claim 13, wherein the groove depth ranges from about 0.098 inches (about 2.489 mm) to about 0.101 inches (about 2.565 mm).

15. The method of claim 10, wherein the groove diameter is defined by a first location of the circumferential face and a second, oppositely disposed location of the circumferential face.

16. The method of claim 10, wherein the groove width is defined by a distance between the axially forward face and the axially aft face.

17. The method of claim 10, wherein the groove depth is defined by a distance between extending from the radially outer surface of the aft region of the compressor inlet housing and the circumferential face of the O-ring groove.
